(19) United States
(12) Patent Application Publication
(10) Pub. No.: US 2019/0100256 A1
(43) Pub. Date: Apr. 4, 2019

(54) TIRE CARRIER AND VEHICLE LIFT APPARATUS

(71) Applicant: Ford Global Technologies, LLC, Dearborn, MI (US)

(72) Inventors: William Reese Cherry, Madison Heights, MI (US); Peter Simeon Lazarevski, Dearborn, MI (US)

(21) Appl. No.: 15/721,275

(22) Filed: Sep. 29, 2017

(51) Int. Cl. B62D 43/00; B66F 3/12; B62D 43/02; B60S 9/04

(52) U.S. Cl. CPC B62D 43/002; B66F 3/12; B66F 2700/04; B60S 9/04; B62D 43/02

(57) ABSTRACT

A tire carrier and vehicle lift apparatus is disclosed. A scissor jack includes a first bracket fixed to the jack, the first bracket to removably mount the jack to a vehicle. The apparatus also includes a second bracket fixed to the jack opposite the first bracket, the second bracket to hold a wheel for the vehicle, wherein operation of the jack while the bracket is mounted to the vehicle is to lower the wheel toward the ground.

### FIELD OF THE DISCLOSURE

This disclosure relates generally to tire carriers and, more particularly, to tire carrier and vehicle lift apparatus.

### BACKGROUND

In recent years, tire carriers have become increasingly sophisticated. For example, some tire carriers may be attached to a back hitch of a vehicle via multiple tubes and fasteners. In other examples, tire carriers are attached to an undercarriage of the vehicle via a tire hoist. Typically, these tire carriers require a separate device to lift the vehicle.

### SUMMARY

A scissor jack including a first bracket fixed to the jack, the first bracket to removably mount the jack to a vehicle. The jack also includes a second bracket fixed to the jack opposite the first bracket, the second bracket to hold a wheel for the vehicle, wherein operation of the jack while the bracket is mounted to the vehicle is to lower the wheel toward the ground.

A scissor jack including first and second arms pivotably coupled to a head portion. The jack also includes a mounting plate fixed to the head portion and configured to be mounted to a vehicle body. The jack also includes third and fourth arms pivotably coupled to a foot portion, the foot portion to removably hold a vehicle wheel.

A scissor jack including means for mounting the jack to a body of a vehicle. The jack also includes means for removably holding a wheel of the vehicle while the jack is mounted to the body of the vehicle.

### BRIEF DESCRIPTION OF THE DRAWINGS

FIG. 1 illustrates an example vehicle including an example tire carrier.

FIG. 2 illustrates an isometric view of the example tire carrier of FIG. 1.

FIGS. 3A-3B illustrate isometric views of a first bracket of the example tire carrier of FIGS. 1-2.

FIGS. 4A-4B illustrate isometric views of a second bracket of the example tire carrier of FIGS. 1-2.

The figures are not to scale. Wherever possible, the same reference numbers will be used throughout the drawing(s) and accompanying written description to refer to the same or like parts.

### DETAILED DESCRIPTION

Known tire carriers are typically mounted on a rear of a vehicle via tubes (e.g., a tubular frame) and bolts or via a tire hoist attached to the undercarriage of the vehicle. In these examples, a spare tire must be lifted by a person to be attached to the rear of the vehicle, or pushed underneath the vehicle in the case of the tire hoist. These known tire carriers are troublesome because spare tires can be heavy (e.g., between 50-100 lbs) and, thus, difficult to move. When a flat tire is to be replaced, a separate device (e.g., a jack) is required to lift the vehicle. After replacing the flat tire with the spare tire, the flat tire is typically attached to the tire carrier. This process can be exhausting because the person changing the tire may have to lift multiple tires without assistance. In some cases, the person may not be physically capable of removing/lifting the tire.

The examples disclosed herein relate to an example tire carrier and vehicle lift apparatus to enable a wheel to be carried/removed from the rear of a vehicle, and to lift the vehicle. As used herein, the terms “wheel” and “tire” refer to a tire mounted on a rim. The example apparatus may include a scissor jack. In the disclosed examples, a first bracket is fixed to the jack and the first bracket is to removably mount the jack to the vehicle. In some examples, the first bracket includes a plurality of apertures including elongated slots that are utilized to removably mount the jack to the vehicle. In the disclosed examples, the first bracket includes a substantially flat head portion to assist stabilizing the jack when lifting the vehicle. In the disclosed examples, the first bracket includes a groove that receives a first end of the jack.

In the disclosed examples, a second bracket is fixed to the jack opposite the first bracket to hold a wheel of the vehicle. In the disclosed examples, when the jack is operated while the first bracket is mounted to the vehicle, the second bracket is to lower the wheel mounted thereto toward the ground. In the disclosed examples, the second bracket includes protrusions that extend from a face of the second bracket through the wheel to mount the wheel to the jack. The protrusions may be threaded to secure the wheel via threaded fasteners (e.g., nuts) to the jack. In some examples, the second bracket includes a substantially flat foot portion to assist in stabilizing the jack when operating to lift the vehicle. In the disclosed examples, the second bracket includes a groove that receives a second end of the jack opposite the first end.

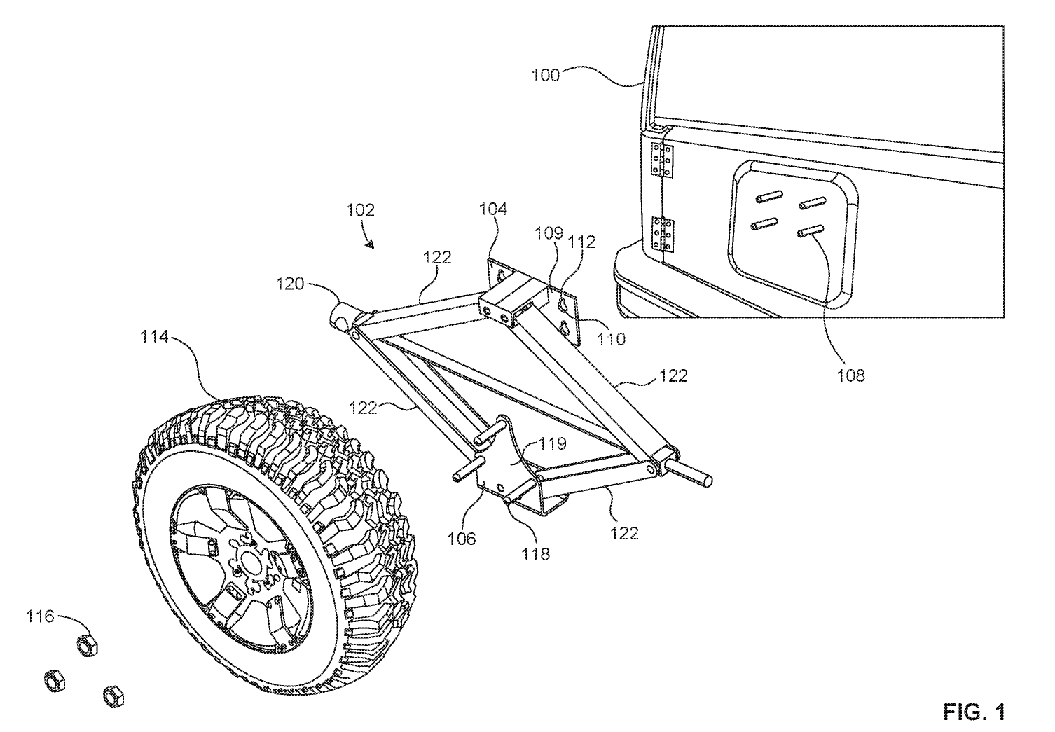

FIG. 1 illustrates an example vehicle 100 including an example tire carrier 102 having a first bracket 104 and a second bracket 106 constructed in accordance with the teachings of this disclosure. The vehicle 100 may be a may be a sport-utility vehicle, a light-duty truck, a heavy-duty truck, etc. In the illustrated example, the first bracket 104 of the tire carrier 102 is removably coupled and/or mounted to studs 108 of the vehicle 100. In some examples, the first bracket 104 may be removably coupled to the studs 108 via a mounting plate 109 including apertures 110, which may have elongated slots 112, as described in more detail below. In the illustrated example, a wheel 114 is removably coupled and/or mounted via fasteners 116 to the second bracket 106 of the example tire carrier 102. In the illustrated example, the fasteners 116 are threadably coupled to protrusions or posts 118 extending from a face 119 of the second bracket 106, as described in more detail below.

To raise/lower the wheel 114, a screw 120 of the tire carrier 102 is operated in a manner similar to known scissor jacks. For example, to lower the wheel 114, the screw 120 is rotated and arms 122 of the tire carrier 102 operate to lower the wheel 114. In the disclosed examples, the tire carrier 102 may be removed from the vehicle 100 by removing the first bracket 104 from the studs 108. As such, the tire carrier 102 may be placed underneath the vehicle 100 and the screw 120 may be rotated to raise the tire carrier 102 and, in turn, lift the vehicle 100.

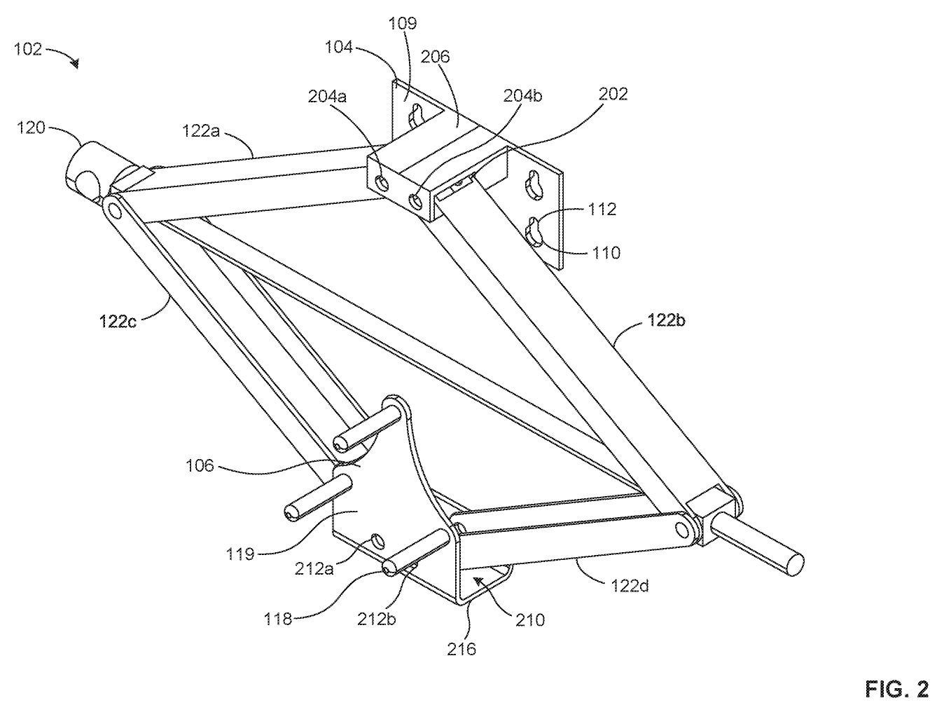

FIG. 2 illustrates an isometric view of the example tire carrier 102 of FIG. 1. The example tire carrier 102 includes the first bracket 104 having the mounting plate 109, the apertures 110 including the elongated slots 112, a groove 202, apertures 204a-b, and a head portion 206. The example tire carrier 102 also includes the second bracket 106 having the protrusions 118, a groove 210, apertures 212a-b, the face 119 and a foot portion 216.

In the illustrated example, the groove 202 of the first bracket 104 receives the arms 122a-b. The apertures 204a-b may receive bolts or pins to couple the bracket 104 to the arms 122a-b. For example, the groove 202 may receive the arm 122a, and the aperture 204a may receive a bolt or pin to pivotably couple the first bracket 104 to the arm 122a. In a similar manner, the groove 202 receives the arm 122b, and the aperture 204b may receive a bolt or pin to pivotably couple the first bracket 104 to the arm 122b. Additionally, the head portion 206 is sized to space the groove 202 from the vehicle 100. For example, the head portion 206 may be sized to extend the groove 202 outward from a bumper of the vehicle 100. In this example, when the tire carrier 102 is operated, the wheel 114 attached to the tire carrier 102 can be lowered to the ground without interfering with the bumper of the vehicle 100. Additionally, the head portion 206 is substantially flat to increase stabilization of the vehicle 100 when the tire carrier 102 is operated as a vehicle jack.

The apertures 110 including the elongated slots 112 facilitate removably coupling the mounting plate 109 to a vehicle. For example, the apertures 110 may be sized to fit over the head of a bolt, and the elongated slots 112 may be sized to fit over the neck of the bolt, but not the head. As such, when the bolt passes through the aperture 110, the mounting plate 109 may be lowered and the neck of the bolt may slide into the elongated slot 112, locking the mounting plate 109 in place. In some examples, the bolt may include a washer and a spring to urge the first bracket 104 against the head of the bolt, further increasing the locking force on the first bracket 104. In some examples, the mounting plate 109 may only include the apertures 110. The mounting plate 109 may use any method for mounting the tire carrier 102 to the vehicle 100. In the illustrated example of FIG. 2, the example first bracket 104 includes four apertures 110 with elongated slots 112. However, any number of apertures 110 may be used depending on the desired location of the tire carrier 102. For example, mounting the first bracket 104 on an existing tire mount may require an alternative mounting plate 109 and/or configuration of apertures 110.

In the illustrated example, the groove 210 of the second bracket 106 receives the arms 122c-d. The apertures 212a-b may receive bolts or pins to couple the second bracket 106 to the arms 122c-d. For example, the groove 210 may receive the arm 122c, and the aperture 212a may receive a bolt or pin to pivotably couple the second bracket 106 to the arm 122c. In a similar manner, the groove 210 receives the arm 122d, and the aperture 212b may receive a bolt or pin to pivotably couple the second bracket 106 to the arm 122d. In the illustrated example, the second bracket 106 includes the protrusions or posts 118 extending from the face 119 of the second bracket 106. The protrusions 118 may be threaded to receive a threaded fastener (e.g., the fasteners 116 of FIG. 1) to secure a wheel of a vehicle. For example, the protrusions 118 may slidably engage a hub of a wheel and the threaded fasteners 116 may be coupled to the ends of the protrusions 118 to secure the wheel to the second bracket 106 and, in turn, the tire carrier 102. Additionally, the foot portion 216 of the second bracket 106 is substantially flat to increase stabilization of a vehicle when the tire carrier 102 is operated as a vehicle jack.

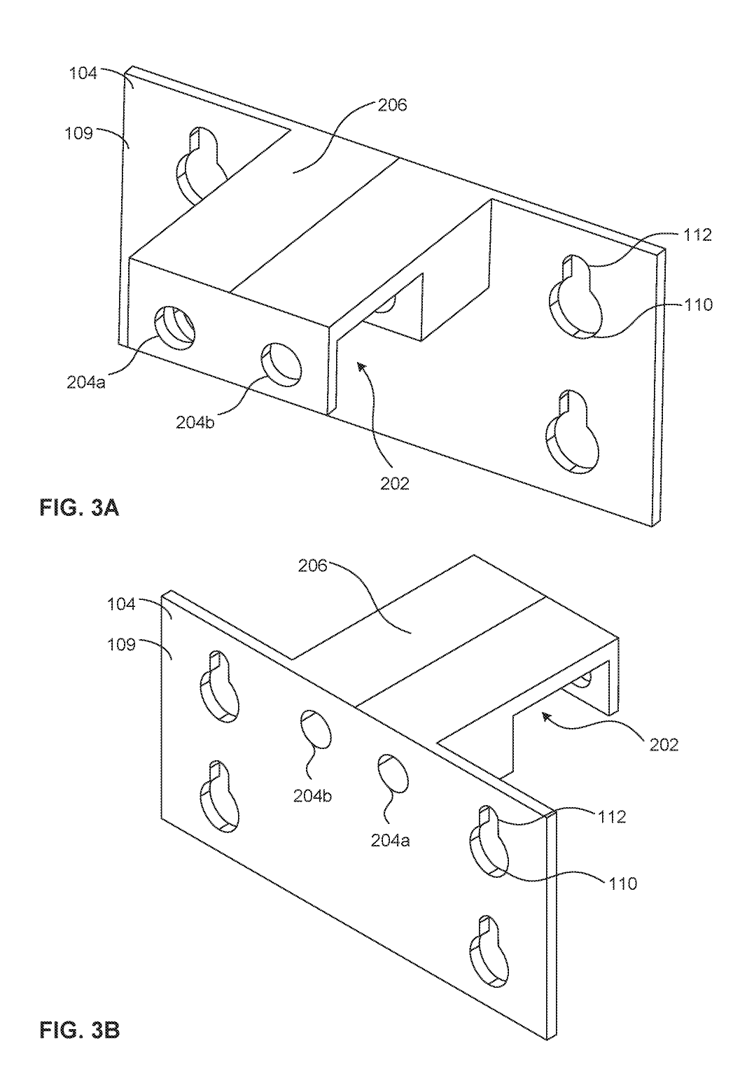

FIGS. 3A-3B illustrate example isometric views of the example first bracket 104 of the tire carrier apparatus 102 of FIGS. 1-2.

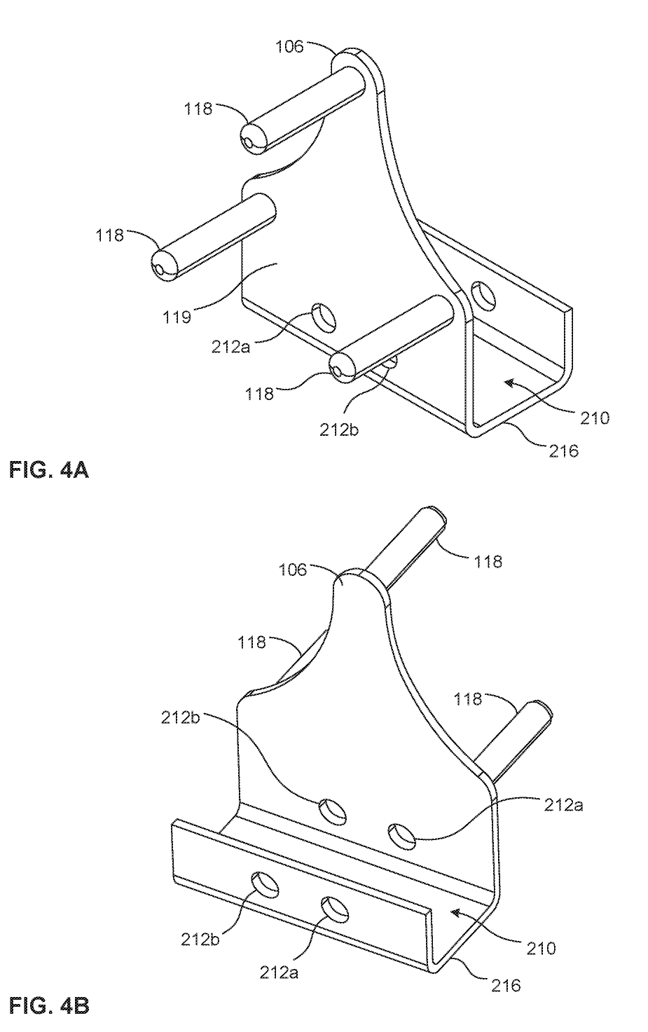

FIGS. 4A-4B illustrate example isometric views of the example second bracket 106 of the tire carrier apparatus 102 of FIGS. 1-2.

From the foregoing, it will be appreciated that example apparatus and articles of manufacture have been disclosed that enable a single device to carry a tire and lift a vehicle. Full size spare tires for trucks and SUVs can weigh over 100 lbs in many cases, and can be mounted high off the ground on the rear of the vehicle. Wheel center for a tailgate mounted spare is normally between two and three feet off the ground. As a result, a lot of weight has to be lifted a large distance by a person changing a tire. Additionally, weight and interior space is at a premium in modern vehicles.

The example disclosed herein provides a scissor jack that holds a spare tire while attached to the vehicle, and which can operated to lower the tire to the ground. The example jack can then be removed from the vehicle, used to lift the vehicle to replace the tire, and then reattached to lift the other tire back into a storage location. Thus, the example jack minimizes added weight to the vehicle and frees up space inside the vehicle by moving the jack to the exterior. This also offers the ability to leave the spare tire at a variety of heights depending on the needs of the situation. For example, the tire can have a normal resting height, then be raised higher for clearance to the trailer hitch for towing.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A scissor jack, comprising:
a first bracket fixed to the jack, the first bracket to removably mount the jack to a vehicle; and
a second bracket fixed to the jack opposite the first bracket, the second bracket to hold a wheel for the vehicle, wherein operation of the jack while the first bracket is mounted to the vehicle is to lower the wheel toward the ground.

2. The scissor jack of claim 1, wherein the first bracket is fixed to a head portion of the jack that pivotably holds arms of the jack.

3. The scissor jack of claim 1, wherein the first bracket includes an aperture to receive a fastener to removably mount the jack to the vehicle.

4. The scissor jack of claim 1, wherein the second bracket includes posts protruding from a face of the second bracket, the posts to slidably engage openings in the wheel to hold the wheel.

5. The scissor jack of claim 1, wherein the second bracket pivotably holds arms of the jack.

6. The scissor jack of claim 5, wherein the second bracket includes a foot portion to engage a ground surface when the jack is operated to lift the vehicle.

7. A scissor jack, comprising:
first and second arms pivotably coupled to a head portion;
a mounting plate fixed to the head portion and configured to be mounted to a vehicle body; and
third and fourth arms pivotably coupled to a foot portion, the foot portion to removably hold a vehicle wheel.

8. The scissor jack of claim 7, wherein the mounting plate is perpendicular to pivot axes of the first and second arms at the head portion.

9. The scissor jack of claim 7, wherein the mounting plate includes elongated apertures to facilitate attachment and removal of the jack to the vehicle body.

10. The scissor jack of claim 7, wherein the foot portion includes a face having protrusions to receive the vehicle wheel.

11. The scissor jack of claim 7, wherein the head portion includes a groove to receive the first and second arms.

12. The scissor jack of claim 11, wherein the head portion includes a protrusion to extend the groove outward from the mounting plate.

13. The scissor jack of claim 7, wherein the foot portion includes a groove to receive the third and fourth arms.

14. A scissor jack, comprising:
means for mounting the jack to a body of a vehicle, the means for mounting including a means for extending the jack outward from the body of the vehicle; and
means for removably holding a wheel of the vehicle while the jack is mounted to the body of the vehicle.

15. The scissor jack of claim 14, wherein the means for mounting the jack further includes means for pivotably holding arms of the jack.

16. The scissor jack of claim 14, wherein the means for mounting includes means for facilitating the mounting and removal of the jack.

17. (canceled)

18. The scissor jack of claim 14, wherein the means for removably holding the wheel includes means for pivotably holding arms of the jack.

19. The scissor jack of claim 14, wherein the means for removably holding the wheel includes means for slidably engaging holes in the wheel.

20. The scissor jack of claim 14, wherein the means for removably holding the wheel includes means for engaging the ground when lifting the vehicle.

21. The scissor jack of claim 3, wherein the aperture includes an elongated opening to receive a fastener to removably mount the jack to the vehicle.
